(19) United States
(12) Patent Application Publication
(10) Pub. No.: US 2007/0075463 A1
(43) Pub. Date: Apr. 5, 2007

(54) Method and apparatus for heating mold by high frequency current

(75) Inventors: Jung-Tang Huang, Taipei (TW); Liang-Tse Lin, Taipei (TW)

Correspondence Address: Jung-Tang Huang, 5F., No.7, Lane 10, Sec. 2, Bade Rd., Da-an District, Taipei City, 106, TW

(73) Assignee: Jung-Tang Huang

(21) Appl. No.: 11/541,613

(22) Filed: Oct. 3, 2006

(30) Foreign Application Priority Data
Oct. 4, 2005 (TW) 094134634

(51) Int. Cl. B29C 35/12

(52) U.S. Cl. 264/489; 264/491; 425/174.8 R; 425/174.8 E

(57) ABSTRACT

The method and apparatus of the invention is used to heat the surface of the mold insert or cavity by high frequency current. There are holes near the heated surface in the mold and the coils can be installed into the holes. The coils surround the heated surface and are conducted with high frequency current. Due to the directional change of the current, the blocks that are surrounded by the coils will be heated by the hysteresis losses and the eddy-current losses. The surface of the mold insert or cavity will be heated rapidly. There are cooling holes set near the heated surface or beside the coil-pipe. The cooling liquid or air can flow in the holes to carry out extra energy and the temperature of the mold will be decreased. The position of the cooling holes, the flow speed and temperature deviation of the liquid and air will influence the temperature of the mold. The method and apparatus will improve the quality of the thermal-plastic products and elevate the number of the cavity.

### TECHNICAL FIELD

This invention relates to the means and apparatus using high frequency current to heat mold surface rapidly. More specifically it relates to build in the induction coils in the mold to heat thermal plastic materials to reduce their flow resistance and easily be filled in the mold cavity.

### BACKGROUND OF THE INVENTION

Injection molding, injection compression molding and hot emboss forming are all processes of heating up plastics to melted state and fill them into mold cavity, then the plastics encloses specific structure of the mold and gets cooled down so as to duplicate mold structure. Generically in this invention plastics mean thermal plastic materials that can be applied in such processes include: plastic, glass, metal, composite material mainly based on plastic, glass and metal. Generally, the mold temperature is lower than the glass transition temperature of plastics, therefore, a condensation layer is created when melted plastic is in contact with mold cavity surface, the thickness ratio between condensation layer and the product thickness rises as the increase while the reduction of the product thickness. When the proportion occupied by the condensation layer is too high, the filling of melted plastic become more difficult which in turn leads to problems such as short-injection, incomplete duplication of the structure and residual stress, etc.

In order to meet the trend of light weight, small form factor, short and tiny need for products nowadays, products made up of plastics has thinner and thinner design, moreover, some microstructures are needed in the whole structure due to special need, for example, backlight panel, optical fiber coupler, etc. If conventional injection molding is used, the process can not be completed due to bad flow characteristics of condensation layer and plastics, therefore, a method to rapidly heat mold cavity surface has been proposed in recent years, some inventions develop rapid cooling method associatively in order to shorten the process cycle time, basically, the prior art heating methods can be divided into steam heating, resistance heating and high frequency induction heating method, here we briefly summarize the prior art as in the followings:

U.S. Pat. No. 2,984,887 uses resistance method to heat the copper or silver layer coated on the mold surface.

U.S. Pat. Nos. 3,671,168 and 3,763,293 use hot fluid to heat the mold cavity through conduction method.

U.S. Pat. No. 4,060,364 uses high frequency current induction to heat the mold.

U.S. Pat. No. 4,340,551 uses high frequency induction heating device to approach and heat specific location of the mold cavity surface before the closing of the mold so that certain mold cavity surface will have temperature higher than the glass transition temperature of plastic materials.

U.S. Pat. No. 2,979,773 uses resistance heating to heat mold cavity surface and so-called variable conduction type heat pipe was used for the cooling.

U.S. Pat. No. 5,232,653 uses low heat equivalent material as mold and used resistance heater unit to heat the mold. The cooling system buried on the mold surface is used to cool the mold.

U.S. Pat. No. 5,762,972 discloses induction heating or dielectric heating to heat the mold, that is, high frequency wave or microwave is used to heat the mold to pre-set temperature within short time.

U.S. Pat. No. 6,846,445 uses a mold to carry with high frequency current, then skin effect and proximity effect are generated on the mold surface by the high frequency current to heat the mold surface.

U.S. Pat. No. 4,201,742 uses mold cavity filled with high temperature and high pressure steam to heat the mold surface, besides, the compressed steam within the mold cavity is released before the filling of plastics into the mold cavity.

U.S. Pat. No. 4,442,061 uses high temperature steam and water to cycle alternatively so as to control the plastic temperature within the mold and mold cavity during the shape-forming cycle of injection molding process.

U.S. Pat. No. 2,004,251,570 uses steam to flow into the guide hole within the mold to heat the mold, besides, after the completion of filling of plastic, cooling water is introduced into the guide hole of the mold to cool it.

US patent JP2000-218356 uses an externally attached flexible induction heating mechanism, therefore, before the closing of the mold, induction heating is used to raise the temperature of the full mold cavity of the mobile side and fixed side mold, then the mold is closed and light metal product is injected completely.

Taiwan patent TW505,616 uses injection compression molding technology to prepare micro system chip and MEMS technology is used to prepare micro heater, wherein the heater is a resistance type micro heater produced by MEMS deposition method.

Taiwan patent TW543,334 uses a micro heater within a mold which can partially control the temperature within the mold. The micro heater is made by thin film process of MEMS process and thick film process such as screen printing, etc. or other methods such as low temperature co-sintering ceramic to prepare the needed micro single layer or multiple layer structure, moreover, this micro heater connect in series and in parallel several geometric shapes to heat the partial mold structure.

The above mentioned inventions adopt resistance type method to heat the mold or heater, then a conduction or radiation method is used to heat the mold cavity surface or specific location. Since the conduction type heating could easily cause temperature gradient and time delay between heating source and the heated surface, and more seriously, the resistor could consume partial electric energy and thermal energy which could be easily released to non-heating area.

The above-mentioned inventions adopt steam heating method to heat the mold and thermal conduction is used to transfer the heat from the mold to the heated surface, however, thermal conduction could easily cause temperature gradient and time delay between heating source and surface to be heated.

The above mentioned inventions adopt high frequency method to heat mold surface. U.S. Pat. No. 6,846,445 introduces high frequency current to the mold, due to skin effect and proximity effect, most of the high frequency current flow on the mold surface. This method can heat the mold cavity surface rapidly, however, to apply high power high frequency current to the mold directly, appropriate insulation and protection actions are needed before it can be practically implemented. Other previously mentioned inventions adopt high frequency heating method, most of them use skin effect and proximity effect to inductively heat the mold surface in the neighborhood of the coils, then thermal conduction is used to transfer the heat to mold cavity or other specific location.

### SUMMARY

First purpose of the current invention is to provide a device and means to rapidly heat and cool down mold surface through high frequency induction method. In this method, coil guide holes are deployed in the neighborhood of mold surface and coils are buried inside the coil guide holes. Coils will enclose mold cavity surface to be heated within the closed area formed by the coils, high frequency current is added to the coils and mold surface is heated by the hysteresis loss and eddy current loss in the mold area enclosed by the coils due to the high frequency current direction change. Furthermore, cooling holes are buried in the neighborhood of coil guide holes and heating surface and cooling liquid or cooling gas are introduced to cool down the mold.

The second purpose of the current invention is to shorten the cycle time of thermoplastic material process in order to save the process cost.

The third purpose of the current invention is to raise the mold cavity temperature to be larger than or equal to the glass transition temperature of the plastic material so that the melted plastic material will have good flow characteristic during the filling stage and the mold structure can be smoothly filled or enclosed, meanwhile, after the completion of the filling, cooling speed is set according to product need so that the occurrence possibility of residual stress and melting line on the product can be reduced and the optical quality of the product can be enhanced.

The fourth purpose of the current invention is to enhance the mold cavity temperature to above the glass transition temperature of plastic so that the thickness proportion occupied by condensation layer can be greatly reduced. During the filling stage of composite plastic material, this can avoid the separation problem between melted plastic and solid additive and better product surface quality can thus be obtained.

The fifth purpose of the current invention is, due to the raise of mold surface temperature to above the glass transition temperature of plastic, to raise mold cavity number on the mold, moreover, because melted plastic can maintain good flow characteristic during the filling stage, a better distributed filling pressure of mold cavity plastic can thus be obtained and product dimension accuracy and production stability can be enhanced.

The sixth purpose of the current invention is to bury coils in the coil guide hole within the mold, and dry cooling air can be filled into the spaces between coil and the wall of guide hole, in this way, both high frequency coil and mold cavity surface can be cooled at the same time, the users can thus select the way they want.

The seventh purpose of the current invention is to solve the very thin space problem in the mold which might lead to difficulty in the flow characteristic of plastic, therefore, sub-millimeter ultra-thin precise injection is thus possible.

The eighth purpose of the current invention is that the current device can let injection molding reach precise requirement as wafer level, a so-called wafer level plastic piece can be produced. If it can be associated with integrated circuit or MEMS device to perform wafer level packaging, many individual packaging costs can thus be saved.

### BRIEF DESCRIPTION OF THE DRAWINGS

The invention may best be understood by reference to the following description taken in conjunction with the accompanying drawings that illustrate specific embodiments of the present invention.

FIG. 1 High frequency induction heating principle.

FIG. 2 Magnetic hysteresis curve.

FIG. 3 High frequency induction heating planar metallic plate assembly.

FIG. 4 Magnetic field distribution of high frequency coil induction metallic block.

FIG. 5 High frequency induction heating mold assembly

FIG. 6 Decomposition diagram of high frequency induction heating mold.

FIG. 7 Cross section diagram 1 of high frequency induction heating mold.

FIG. 8 Cross section diagram 2 of high frequency induction heating mold.

FIG. 9 Mold close diagram of the fixed side and movable side of a mold.

FIG. 10 Coil assembly illustration when the mold is closed.

FIG. 11 Illustration of mold cooling hole and cooling pipeline layout.

FIG. 12 Control system diagram of high frequency induction heating mold.

FIG. 13 Application and embodiment 1 of high frequency induction heating mold.

FIG. 14 Application and embodiment 2 of high frequency induction heating mold.

### DETAILED DESCRIPTION OF PREFERRED EMBODIMENTS

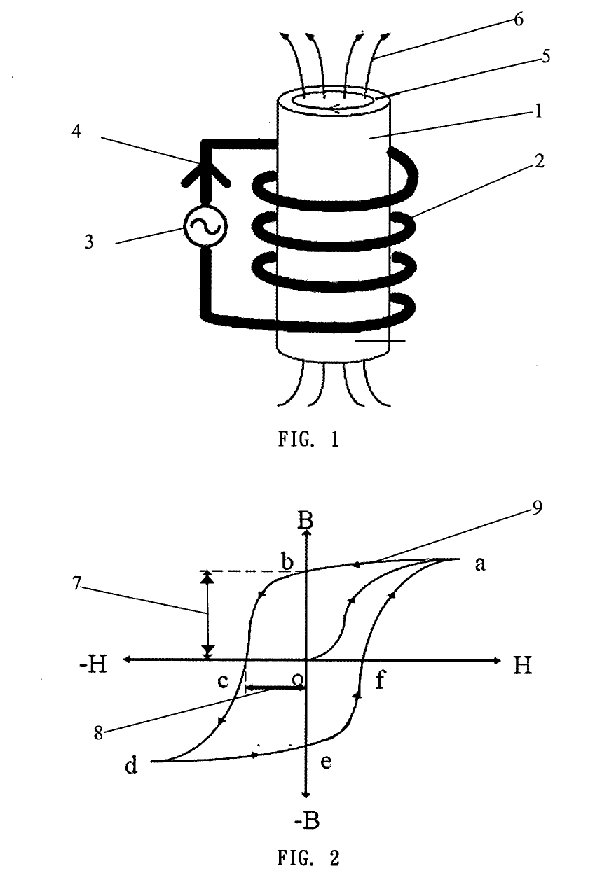

FIG. 1 is an illustration of electromagnetic induction principle, a conductor 01 is enclosed by coil 02, and a high frequency power 03 is added to the coil 02, under the influence of change of external magnetic field 06 generated on specific current direction 04, conductor 01 itself will generate an induction potential to resist magnetic flux change so as to resist the change from external magnetic field 06, this potential is not only related to magnetic flux change but also is positively proportional to the relative movement speed between object and the magnetic flux change, the following formula can be used to represent it:

$$e = - N \frac{ⅆ ϕ}{ⅆ t} - v ϕ \frac{ⅆ N}{ⅆ x}$$

Wherein e: induction potential (volt, V), N: turns of the coil (Turn), ø: magnetic flux (Weber, wb), ν: speed (meter/second, m/s), x: displacement (meter, m), this potential will lead to current (that is, eddy current 05) to flow through the conductor which in turn generate a power. According to Joule's law, it can be written as P_{ν}=ρ·J², wherein P_{ν}is volumetric power density (W/m³), ρ is the resistivity of the material (Ωm), J is current density(A/m²).

Non-contact electromagnetic induction is generated between coil 02 and conductor 01, and conductor 01 will undergo molecular reciprocating movement such as magnetization, de-magnetization, re-magnetization, and the hysteresis loss caused will heat the processed object which in turn cause the temperature rise, this is as shown in FIG. 2. The larger the area of hysteresis loss curve 09 enclosed by a b c d e f, the larger the values of coercivity Hc 08 and residual magnetism Br 07, and of course, the larger the magnetic hysteresis loss. The empirical equation for magnetic hysteresis loss is Pₕ=Kₕ·ƒ·B^{x}ₘ·U, wherein Pₕ: the magnetic hysteresis loss of the object to be processed, Kₕ: magnetic hysteresis coefficient, ƒ: frequency (Hz), Bₘ: maximum magnetic flux density (T), x: coefficient of material, U: volume of the processed object (m³).

After the flow of AC current of different frequencies generated by high frequency power 03 through coil 02, induction potential will be generated due to electromagnetic induction, this potential will generate eddy current 05 on the object to be processed, meanwhile, the current will flow through different cross section of the object to be processed in a way of non-uniform and non-equal flow rate. Object to be processed will generate heat because of resistance, this term eddy current loss 05 is the same as the above mentioned magnetic hysteresis loss, it will finally be converted in the form of heat on the object to be heated. Eddy current loss is Pₑ=Kₑ(Bₘₐₓ·ƒ·t)²(Unit: W/kg), wherein Pₑ: eddy current loss under unit weight (W/kg), Bₘₐₓ: maximum magnetic flux density(T), ƒ: working frequency (Hz), Kₑ: eddy current loss proportional constant, t: the thickness of the object to be heated (m).

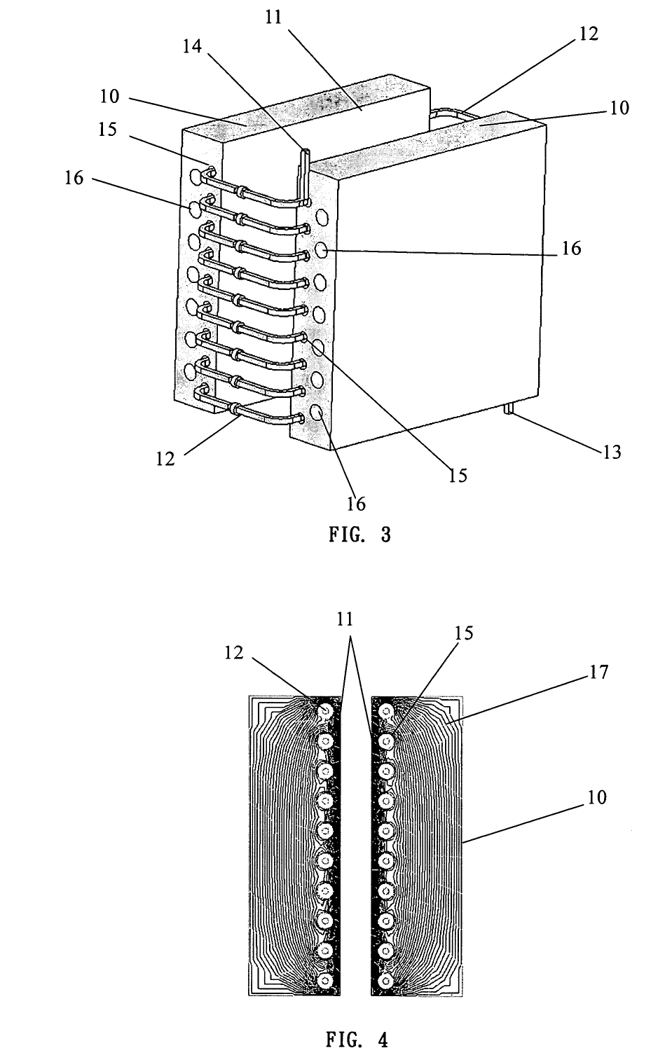

FIG. 3 explains that coil guide hole 15 is installed close to the heating surface 11 of mold insert 10 of the current invention, coil 12 coated with insulated material is used to penetrate the coil guide hole 15 between two molds 10, and the two heating surfaces 11 are made close to each other so that heating surface 11 is enclosed in the zone enclosed by coil 12. Two ends of the coil are respectively current input (output) 13 and current output (input) 14, which are connected to high frequency power supply.

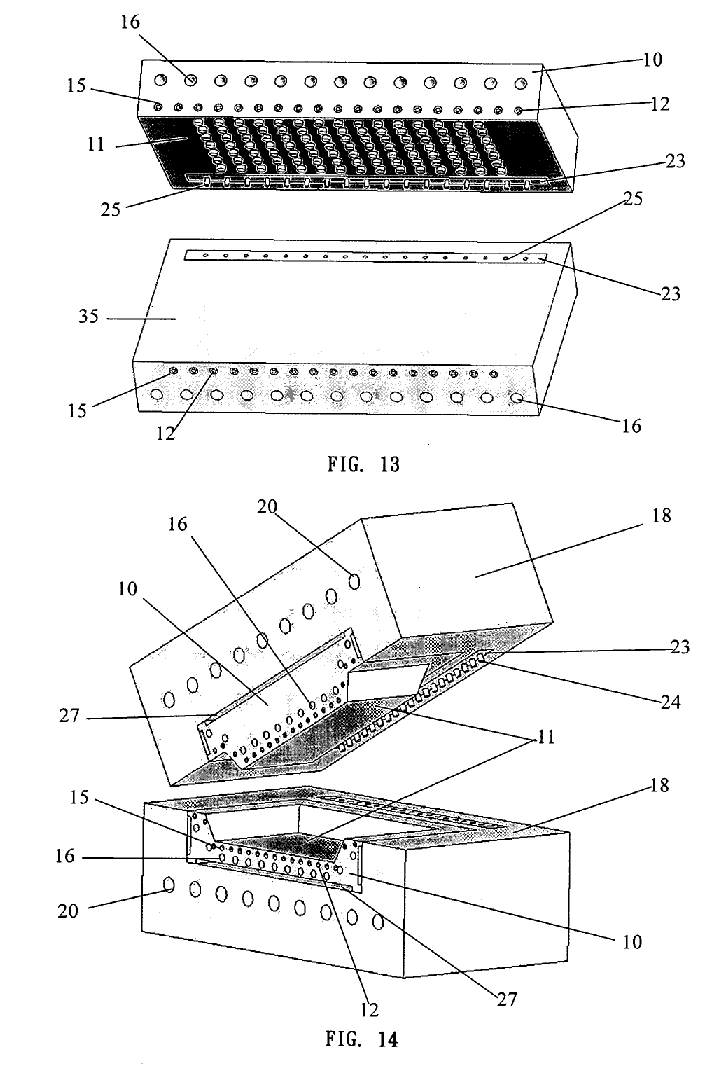

Connect the current input (output) 13 and current output (input) 14 of the coil to high frequency power supply system 34 through external wire (FIG. 13) so that when high frequency current is added to coil 12, the temperature close to the heating surface 11 area will rise rapidly due to magnetic hysteresis loss and eddy current loss of mold insert 10.

FIG. 4 shows that in the current invention coil guide hole 15 is installed at location close to the heating surface 11 of mold insert 10, coil 12 threads through the guide hole 15 and heating surface 11 is enclosed in a zone surrounded by coil 12. Meanwhile, the relative magnetic conduction coefficient of mold insert 10 is much larger than that of the air, therefore, magnetic line of force of magnetic field 06 generated by high frequency current will be mostly focused within mold insert 10, and the heating effect of heating surface 11 will be enhanced; such effect which causes the concentration of eddy current distribution and leads to stronger heating effect of mold insert 10 is called magnetic field concentration effect.

Additionally, cooling hole 16 is installed on mold insert 10, and connector for cooling pipe 22 and external cooling pipe are connected to cooling liquid supply system 32 (FIG. 13). Low temperature liquid or gas is introduced into cooling hole 16, it absorbs the additional heat generated by high frequency induction heating through temperature conduction effect or it cools mold insert 10 and heating surface 11 during plastic condensation stage. The installation location and quantity of cooling hole 16 can be adjusted according to temperature control purpose, besides, the temperature of heating surface 11 of mold insert 10 can be adjusted through the temperature and flow rate of the liquid or gas introduced into cooling hole 16. The followings are the detailed embodiments of the current method:

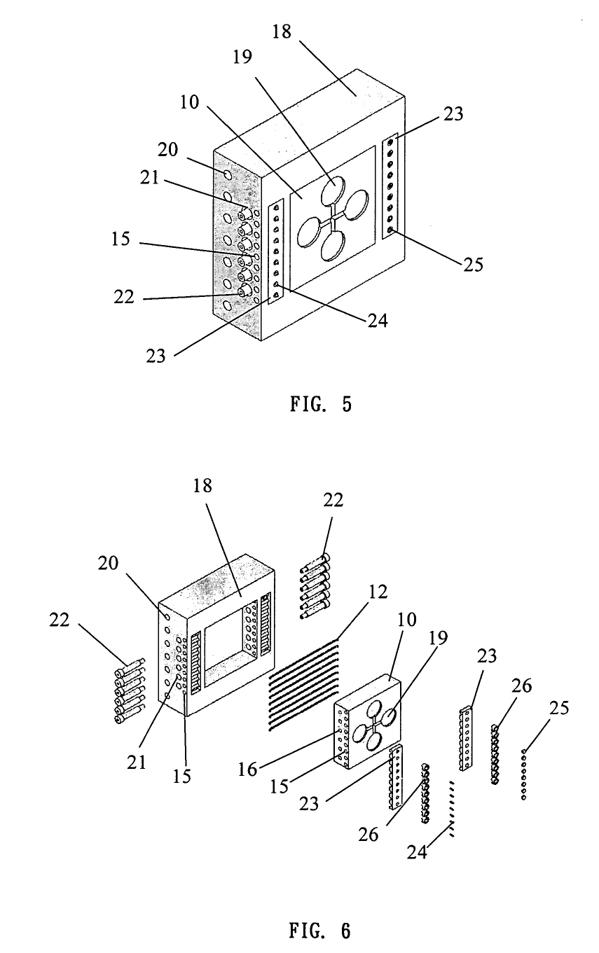

1. FIG. 5 illustrates method and apparatus of the current invention which uses high frequency current to generate heat at a location close to mold cavity 19 surface through magnetic hysteresis loss and eddy current loss to rapidly heat the surface of mold insert 10. Mold insert 10 comprising of mold cavity 19 is installed on mold base 18, mold insert 10 should be in a structure having coil guide hole 15 and cooling hole 16, moreover, the cooling hole connector 22 passes the guide hole for cooling pipe 21 on mold base 18 and gets connected to cooling liquid supply system 32 through guide tube. The decomposition diagram of high frequency induction heating apparatus is as shown in FIG. 6.

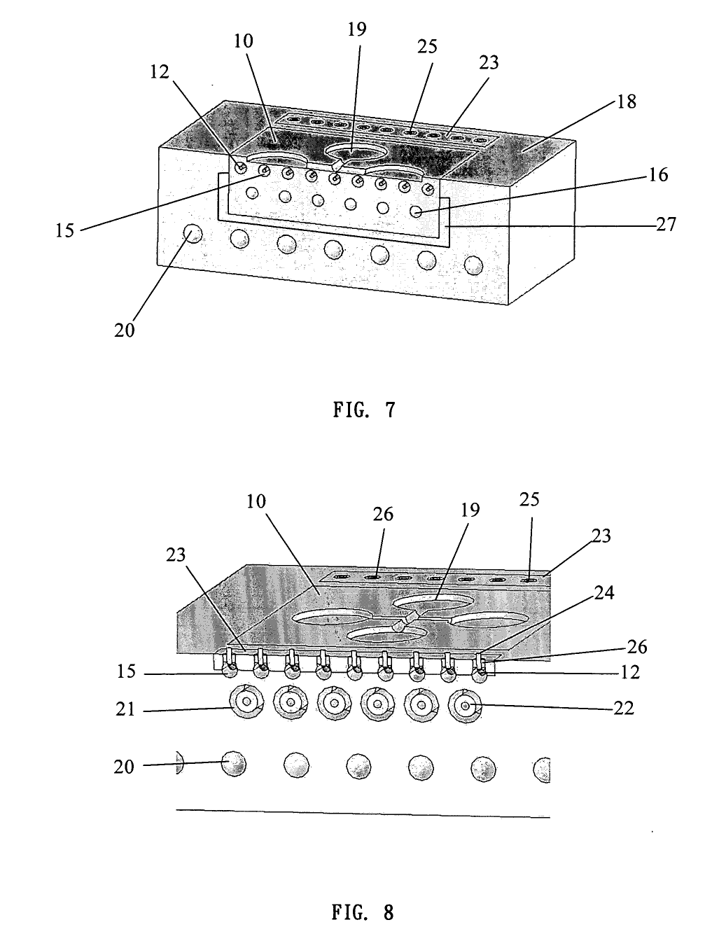

2. Coil 12 is buried in coil guide hole 15 of mold insert 10, both of its ends are connected to the terminal connector 24 and terminal hole 25 of terminal bench 23 respectively, this is as shown in FIG. 7 and FIG. 8, insulation sleeve 26 is used between terminal connector 24 and terminal bench 23 and between terminal hole 25 and terminal bench 23 to insulate and avoid electrical conduction.

3. Assemble mold insert 10 and terminal bench 23 in mold base 18 and use connector for cooling pipe 22 to pass guide hole for cooling pipe 21 on mold base 18 and get connected to cooling hole 16 of mold insert 10, connector for cooling pipe 22 is connected to cooling liquid supply system 32 through guide pipe, a heat insulation layer 27 is placed between mold insert 10 and mold base 18 to stop the transfer of extra heat to mold base, this thus completes high frequency induction heating assembly apparatus and is as shown in FIGS. 7 and 8. The heat insulation layer 27 can be at least more than one heat isolation block installed in between each mold insert and mold base so that the temperature change is limited to within the mold insert. The heat isolation block is material of low thermal conduction coefficient, high mechanical strength and small thermal expansion coefficient.

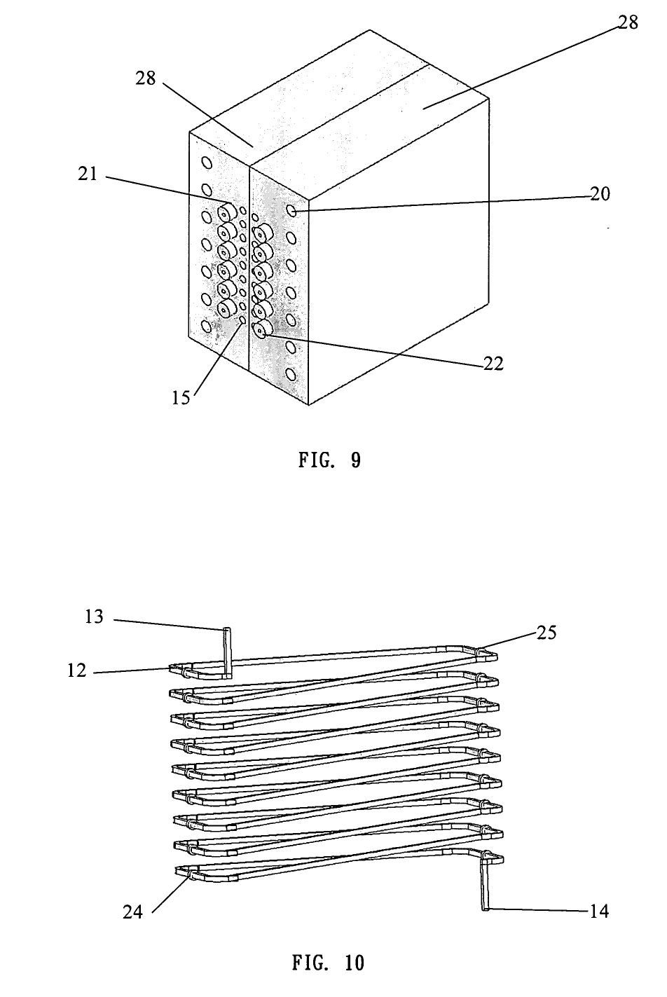

4. When two mold cavity surfaces of high frequency induction heating mold assembly 28 approach or get close to each other, terminal hole 25 and terminal connector 24 on the terminal bench 23 of the mold will get in contact with terminal connector 24 and terminal hole 25 on another mold respectively, coil 12 of two molds then forms a closed coil which encloses heating surface, this is as shown in FIG. 9, the connection method of coil 12 disclosed in the current invention is not limited to the connection of terminal bench connector 24 to terminal bench hole 25. For coil 12 of two adjacent molds, connection methods such as flexible coil or sliding type connector can all reach the purpose of enclosing heating surface 11 within the zone enclosed by coil 12.

5. Through the use of the different installation method of coil guide hole 15 or the connection order between the terminal hole 25 and terminal connector 24 on terminal bench 23, we can install coil 12 in series or in parallel (FIG. 10).

6. Coil 12 is connected to high frequency power supply system 34 outside the mold, this is as shown in FIG. 12, and power control switch 31 is used to control the current, frequency, power and turn-on and turn-off. The frequency of high frequency current can be in the range from 50 Hz to 1 Hz or from 1 Hz to 500 MHz, respectively, depending on the requirements of the applications.

7. In order to prevent residual electrical charge and magnetic field on the mold after the high frequency induction heating on the mold assembly 28, grounding 33 is connected through another conducting wire, and grounding control switch 30 is used to control the conducting or non-conducting of the conducting wire.

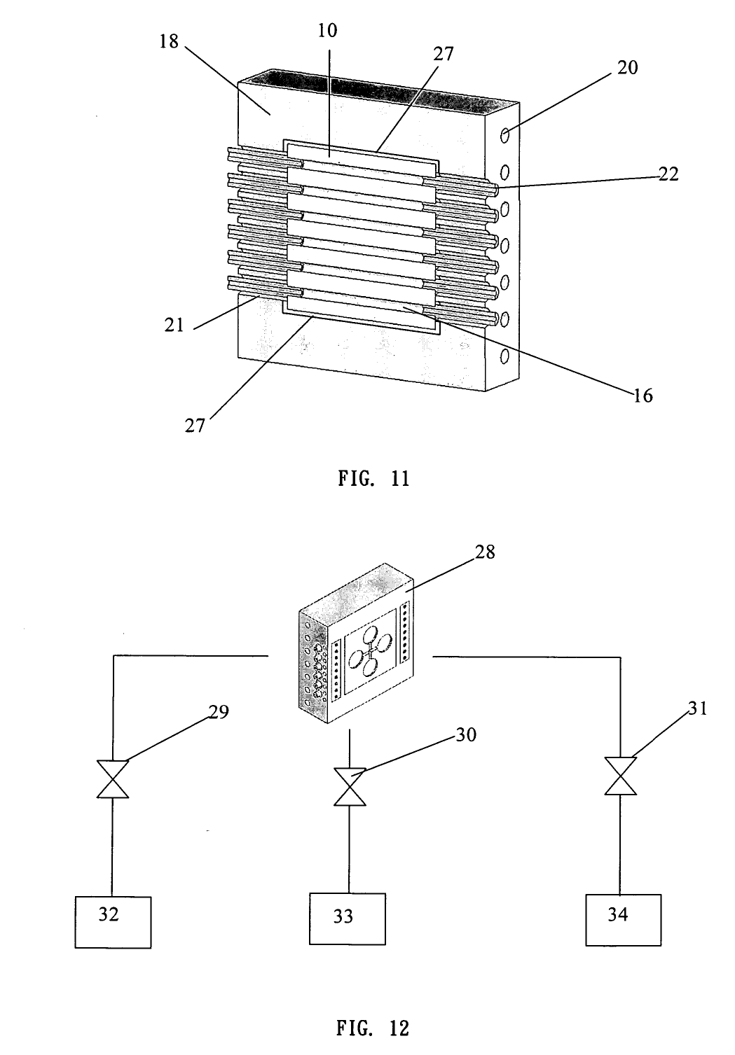

8. As in FIG. 11, connector for cooling pipe 22 penetrates guide hole for cooling pipe 21 on mold base 18 and gets connected to cooling hole 16 of mold insert 10, connector for cooling pipe 22 can be connected to more than one cooling liquid supply system 32 through guide pipe, wherein the system supplies cooling liquid or cooling gas and cooling liquid control valve 29 is used to control the flow rate of the fluid. Through the control of the fluid temperature and flow rate, the temperature of mold insert 10 and heating surface 11 can then be controlled, this is as shown in FIG. 12.

9. The mold cooling water hole 20 of mold base 18 is connected to mold temperature machine through pipeline so that liquid with constant temperature is circulated, for example, water or oil, to absorb extra heat generated in the non-heating zone.

10. High frequency induction heating mold assembly 28 is added with high frequency current through coil 12 so that mold cavity 19 or heating surface 11 will have temperature higher than or close to the glass transition temperature of the thermoplastic material, therefore, when thermoplastic material is filled into the mold cavity or is used to copy special structure, the material can keep good flow properties and the thermoplastic material filling stage can thus be completed smoothly. The properties of thermoplastic material such as transferring property, optical property and product precision, moreover, due to good flow properties of the thermoplastic material in the filling stage, the stress generated on mold structure by thermoplastic material can thus be reduced during the filling stage and the lifetime of the mold can thus be lengthened.

11. During the cooling stage of the mold, cooling liquid is introduced through cooling hole 16 within the mold to rapidly cool down the temperature of coil guide hole 15 and heating surface 11. The cooling liquid can be low temperature air, low temperature liquid or any structure which uses fluid for the cooling, for example, using heat pipe to control the temperature. When the plastic has temperature lower than the glass transition temperature, the process is then completed, and the purpose of shortening process cycle time can thus be achieved.

12. Introduce low temperature fluid to the space between coil guide hole 15 and coil 12 to help the cooling of mold, temperature control and prevention of the bum down of coil 12 due to overheat by the overload carrying of electrical current. Here the coil 12 is electrical conducting material, it can be either solid or hollow wire, and moreover, it is coated or supported by insulated frame.

High frequency induction heating is used in the current invention to generate magnetic hysteresis loss and eddy current loss on the peripherals of the surface of heating body so as to heat the mold, therefore, the melted liquid plastic will not contact with low temperature surface which might generate a condensation layer on the mold cavity surface, moreover, it can be used as a heat source to rapidly soften solid plastic material, and the applications are not just limited to processes such as injection molding, injection compression molding, and hot embossing. The main purpose of the current invention is to provide a method to rapidly heat and cool down the work surface of a mold, it is more specifically related to a process of special structure prepared by the mold. In the current invention, injection molding and hot embossing will be used as the preferred embodiments of the current invention:

### Embodiment 1

As in FIG. 13, it is an illustration of mold for hot embossing, the upper structure is hot embossing mold insert 10 having special structure surface as heating surface 11, and coil guide hole 15 is installed in the neighborhood of heating surface, coil 12 is installed inside the guide hole. Both sides of the coil are connected respectively to two coil terminal benches 23, on the terminal bench 23 are installed with terminal hole 25 and terminal connector 24 respectively, additionally, cooling hole 16 is installed on mold insert 10, which is connected to cooling liquid supply system 32 through guide tube, the hole can be introduced with cooling liquid or gas and the temperature on the heating surface 11 of mold insert 10 is controlled by the temperature and flow rate of cooling liquid.

The lower part structure in FIG. 13 is hot embossing carrier bench having an upper surface of carrier bench 35 which is used to carry thermal plastic material on and to support the downward force exerted by the upper mold insert 10 during the hot embossing stage. Coil guide hole 15 is installed at a location close to the carrier surface 35, current coil 12 is buried inside the guide hole and both sides of coil are connected respectively to coil terminal connector 24 and terminal hole 25 are installed on terminal bench, moreover, cooling hole 16 is installed inside hot embossing carrier bench which is connected to cooling liquid supply system 32 through pipeline. Furthermore, cooling water is introduced to control the temperature of hot embossing carrier bench through cooling water temperature and flow rate. When upper mold insert 10 moves downward to close to hot embossing carrier bench, terminal connector 24 will be connected to terminal hole 25 so that coil will form a enclosed zone closed by coil, then connect coil 12 to high frequency power supply system 34 and high frequency current to generate alternatively leftward and rightward magnetic field in the neighborhood of heating surface 11. Because of magnetic field change, magnetic hysteresis loss and eddy current loss will be generated on the heating surface so that the temperature of heating surface 11 will rise rapidly, then put thermoplastic material to perform hot embossing process.

After the completion of hot embossing, close high frequency power control switch 31 and activate high frequency grounding control switch 30 to remove extra electric charge and magnetic field from mold insert 10 and let magnetic energy stored in the high frequency coil get released, at this moment, activate cooling liquid control valve 29 and input large amount of cooling water to perform the cooling of mold insert 10. Move mold insert 10 upward when mold insert 10 has a temperature lower than the glass transition temperature of plastic so that the connection between terminal hole 25 and terminal connector 24 is released and hot embossing process is then completed.

### Embodiment 2

As shown in FIG. 14, it is a mold illustration for injection molding, both upper part structures are fixed and movable mold inserts 10 respectively. Both mold insert heating surfaces 11 face each other, coil guide hole 15 is installed close to heating surface and coil 12 is installed respectively inside the guide hole. Both ends of coil are connected respectively to terminal hole 25 and terminal connector 24 of terminal bench, and then the coil 12 is connected to high frequency current supply system 34.

Install cooling hole 16 on mold insert 10, connect it to cooling liquid supply system 32 through cooling pipe connector 22 and pipeline, then introduce cooling water, use the temperature and flow rate of cooling water to control the temperature of mold insert 10 and heating surface 11.

When two heating surfaces 11 get close to each other and when terminal hole 24 and terminal connector 25 on two molds get close to each other, high frequency coil will form a ring enclosure coil (as in FIG. 10), then connect coil 12 to high frequency power supply system 34, add high frequency current to generate alternatively leftward and rightward magnetic field in the neighborhood of heating surface 11. Because of magnetic field change, magnetic hysteresis loss and eddy current loss will be generated on the heating surface so that the temperature of heating surface 11 will rise rapidly. When the temperature of mold cavity is higher than the glass transition temperature of plastic, the injection molding process can then be performed.

After the completion of injection process, turn off high frequency power control switch 31 and activate high frequency grounding control switch 30 to remove extra electric charge and magnetic field from mold insert 10 and let magnetic energy be stored in the high frequency coil get released, at this moment, open cooling liquid control valve 29 and introduce cooling water to perform the cooling of mold insert 10. Move the mold insert 10 to be separate when mold insert 10 has a temperature lower than the glass transition temperature of plastic so that the connection between terminal hole 25 and terminal connector 24 is released and injection molding process is then completed.

What is claimed is:

1. A method for heating two mold inserts facing each other through high frequency current having steps of:
two mold inserts having heating surface face each other, at least more than one coil guide hole approaching heating surface of first mold, let coil penetrate coil guide hole, and the penetrated coil will be connected to the coil which penetrates the second mold coil guide hole through a coil connector, then at least one coil assembly which encloses two mold insert heating surfaces having face to face to each other is formed, moreover, ends of the coil assembly are connected to high frequency power supply system, high frequency current is added to the coil through high frequency power supply system to heat mold insert heating surface, then adjust the power output and frequency to control the heating speed and temperature of mold insert heating surface.

2. The method of claim 1 wherein coil is electrical conducting material, either solid or hollow wire, moreover, and coated or supported by insulated material.

3. The method of claim 1 wherein the connection method of coil connector is discrete type or flexible or sliding type.

4. The method of claim 1 wherein coil assembly is connected to high frequency power supply system in series or in parallel.

5. The method of claim 1 wherein cooling liquid is introduced in the space between coil guide hole and coil so as to control the temperature of coil.

6. The method of claim 1 wherein cooling liquid is introduced inside the hollow wire to control the temperature of wire.

7. The method of claim 1 wherein at least more than one cooling hole is installed on each mold, then connected to cooling liquid supply system through guide pipe, thus the flow rate and temperature of gas or liquid flow inside are adjusted to control the mold temperature.

8. The method of claim 7 wherein the cooling liquid is low temperature air, low temperature liquid or any structure which uses fluid for the cooling, for example, using heat pipe to control the temperature.

9. The method of claim 1 wherein at least more than one heat isolation block is installed in between each mold insert and mold base so that the temperature change is limited to within the mold insert.

10. The method of claim 9 wherein the heat isolation block is material of low thermal conduction coefficient, high mechanical strength and small thermal expansion coefficient.

11. The method of claim 1 wherein heating two mold inserts facing each other would be a method for heating one surface of a mold insert through high frequency current having steps of:
at least more than one coil guide hole within a mold insert approaching heating surface, let coil penetrate coil guide hole, the penetrated coil is then connected to at least more than one coil external to the mold insert through a conducting connector, then at least one coil assembly which encloses mold insert heating surface is formed, moreover, end of coil assembly is connected to high frequency power supply system, through the high frequency current sent out by high frequency power supply system, mold insert heating surface is heated, then adjust output power and frequency to control the heating speed and temperature of mold insert heating surface.

12. An apparatus using high frequency coil for the heating of mold insert surface, having the following features:
at least more than one mold insert having one heating surface on it, and at least more than one coil guide hole is penetrated through both sides of heating surface;
at least more than one coil wherein the coil is penetrated into the coil guide hole of the mold insert;
at least more than one coil connector wherein the coil connector connects the coil end that penetrates through two adjacent mold inserts into a coil assembly; moreover, the end of coil assembly is connected to high frequency power supply system.

13. The apparatus of claim 12 wherein coil guide hole is introduced with cooling liquid.

14. The apparatus of claim 12 wherein coil is electrical conducting material, either solid or hollow wire, moreover, coated or supported by insulated material.

15. The apparatus of claim 12 wherein the connection method of coil connector is discrete type or flexible or sliding type.

16. The apparatus of claim 12 wherein coil assembly is connected to high frequency power supply system in series or in parallel.

17. The apparatus of claim 12 wherein coils are connected by coil connector into one body so that two heating surfaces are enclosed the zone enclosed by the coil assembly.

18. The apparatus of claim 12 wherein coils are connected by coil connector into one body, so that both ends of coil will form current input (output) end and current output (input) end.

19. The apparatus of claim 12 wherein cooling liquid is introduced in the space between coil guide hole and coil so as to control the coil temperature.

20. The apparatus of claim 12 wherein cooling liquid is introduced into the hollow wire so as to control the coil temperature.
